(19) United States
(12) Patent Application Publication
(10) Pub. No.: US 2026/0063654 A1
(43) Pub. Date: Mar. 5, 2026

(54) TEST SYSTEM FOR AN OPTICAL INSPECTION DEVICE, METHOD FOR OPERATING

(71) Applicant: Robert Bosch GmbH, Stuttgart (DE)

(72) Inventor: Yashwant Kolluru, Reutlingen (DE)

(21) Appl. No.: 19/309,945

(22) Filed: Aug. 26, 2025

(30) Foreign Application Priority Data
Aug. 30, 2024 (DE) 10 2024 208 275.9

(51) Int. Cl. G01N 35/00; G01N 21/88

(52) U.S. Cl. CPC G01N 35/00693; G01N 21/88; G01N 2035/00702

(57) ABSTRACT

A test system for an optical inspection device of an automated assembly machine. The test system includes a carrier for holding at least one assembly element to be assembled, and a transport device for transporting the carrier into a test position and into a rest position away from the test position. The optical inspection device can be assigned or is assigned to the test position. The carrier includes a first holder for a first assembly element and a second holder for a second assembly element, wherein the holders are fixedly disposed relative to one another on the carrier.

### FIELD

The present invention relates to a test system for an optical inspection device of an automated assembly machine, including a carrier for holding at least one assembly element to be assembled, and including a transport device for transporting the carrier into a test position and into a rest position away from the test position, wherein the at least one optical inspection device can be assigned or is assigned to the test position.

The present invention also relates to a method for operating the above-described test system.

### BACKGROUND INFORMATION

The manufacturing industry is heavily focused on the quality of the products it manufactures and uses automated inspection devices and assembly machines in process lines in which multiple assembly elements are to be connected to one another. To optimize the joining of two assembly elements, the position and alignment of the assembly elements is optically acquired prior to assembly, to then ensure that the assembly elements are optimally brought together depending on the acquired position and alignment. Poorly aligned assembly elements can lead to waste and incorrect parts, which can in turn lead to increased production costs. The use of certain inspection devices for the optical inspection of component features, such as surface structure or dimensions is conventional.

The test system according to the present invention may have an advantage that the capabilities of the optical inspection device can be determined in an advantageous manner and can then later compensate or be used in the assembly process. An advantageous configuration of the test system ensures that, for the calibration and/or acquisition of the working parameters of the inspection device, the acquired operating parameters depend only on the inspection device and compensation or consideration in the assembly process is advantageously possible. According to an example embodiment of the present invention, the carrier comprises a first holder for a first assembly element and a second holder for a second assembly element for this purpose, wherein the holders are fixedly disposed relative to one another on the carrier. This ensures that the assembly elements are always aligned to one another in the same way, in particular in the test position, which ensures that deviations in the optical acquisition of the assembly elements arise solely depending on the inspection device itself. The deviations can thus be traced back to the inspection device and advantageously taken into account when using the inspection device in assembly operation. This in particular makes it possible to calibrate the inspection device, which enables reliable acquisition and alignment of the assembly elements relative to one another during operation of the assembly machine.

According to an example embodiment of the present invention, the holders preferably each comprise at least one clamping element for fastening the respective assembly element. The respective clamping element advantageously makes it possible to secure the assembly elements to the respective holder. This ensures that the assembly element is securely and permanently fastened to the carrier without damaging it, so that the assembly element can be moved with the carrier. This in particular ensures that relative movement between the assembly element and the holder or carrier is prevented when the carrier is moved by the transport device.

According to an example embodiment of the present invention, the carrier preferably comprises a first section which holds the first holder and a second section which holds the second holder, wherein the first section and the second section are disposed in a respective plane and the planes are offset and/or inclined relative to one another. This ensures that the assembly elements are advantageously assigned to the inspection device in the test position. The arrangement on different sections ensures a clear separation of the assembly elements by the inspection device from one another. The holders can be disposed on sides of the sections that face away from one another or on sides of the sections that face the same direction.

The carrier is particularly preferably formed in one piece with the first and the second sections. This results in a particularly strong connection of the two sections or holders with one another, which reliably prevents relative displacement between the assembly elements during transport to the test position and from the test position to the rest position.

According to a preferred embodiment of the present invention, the carrier has a U-shaped profile with two spaced-apart opposite legs and a connecting section which connects the legs to one another. As a result of the U-shape, the two legs that carry the holders and thus form the above-described sections, are opposite one another and can thus enclose at least parts of an inspection device. The U-shape results in a rigid and stable configuration of the carrier.

According to an example embodiment of the present invention, the holders are preferably disposed on the sides of the legs that face one another. The holders are therefore disposed on the inner side of the U-shape and, for example, opposite to one another. The inspection device can thus be disposed between the legs and the holders, for instance. Among other things, this has the advantage that an optical inspection of the assembly elements fastened to the holders can be carried out by only one camera of the inspection device.

For this purpose, the inspection device preferably comprises an optical prism that is positioned between the legs, at least when the carrier is in the test position. The optical prism enables the inspection device to optically acquire and evaluate both assembly elements simultaneously with only one camera.

According to an alternative embodiment of the present invention, the carrier has a Z-shaped profile, wherein the first section and the second section are connected to one another by a transverse section that is oriented perpendicular or at an angle to the longitudinal extension of the first and/or the second section. The cross-section thus lies between the two sections, wherein, in contrast to the U-shape, the sections do not project from the cross-section in the same direction, but rather in different directions, which results in the Z-shape. According to another embodiment of the present invention, a carrier is configured with an L-shaped profile, in which each leg of the L-shape is formed by one of the sections.

According to a preferred further development of the present invention, the transport device comprises at least one rail guide and/or a conveyor belt that can be connected or is connected to the carrier. The rail guide ensures that the carrier can be moved safely from the rest position to the test position and back again. The conveyor belt provides a reliable and precise drive option. The carrier can alternatively also be moved by the transport device using a spindle drive or another type of linear drive. According to an alternative embodiment of the present invention, the transport device comprises a robot arm for transporting or moving the carrier.

In a method according to an example embodiment of the present invention, the carrier with assembly elements fastened to it is repeatedly moved from the rest position to the test position by the transport device, and each time after reaching the test position, the assembly elements are examined by the inspection device, and the examination results are compared to one another in order to acquire working parameters of the inspection device, in particular of at least one camera of the inspection device.

The inspection device is preferably calibrated depending on the acquired working parameters. Alternatively or additionally, the working parameters are taken into account when using the inspection device in an assembly machine for acquiring, in particular two, assembly elements to be joined together. This results in the aforementioned advantages.

Advantages and preferred features and combinations of features emerge in particular from the disclosure herein. The present invention will be explained in more detail in the following with reference to the figures.

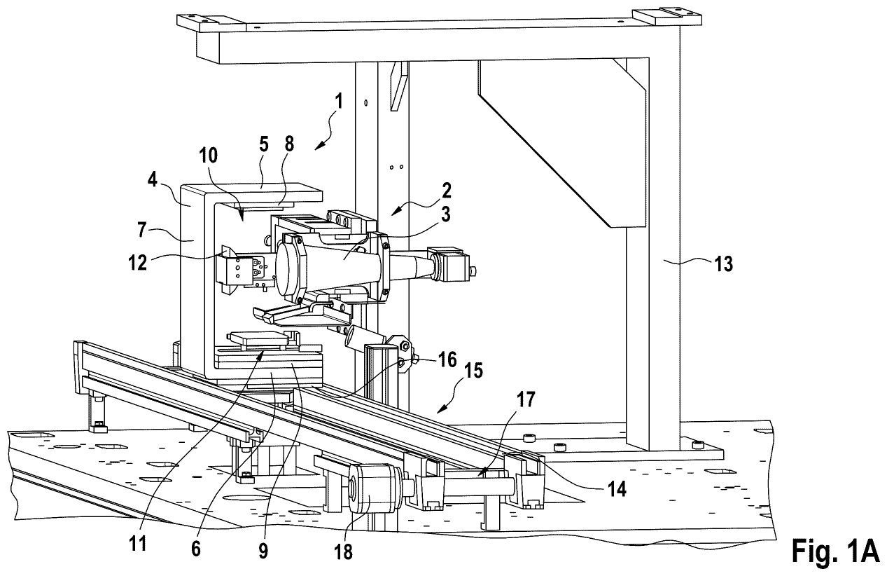

FIG. 1A and B shows a first embodiment example of an advantageous test system, according to the present invention.

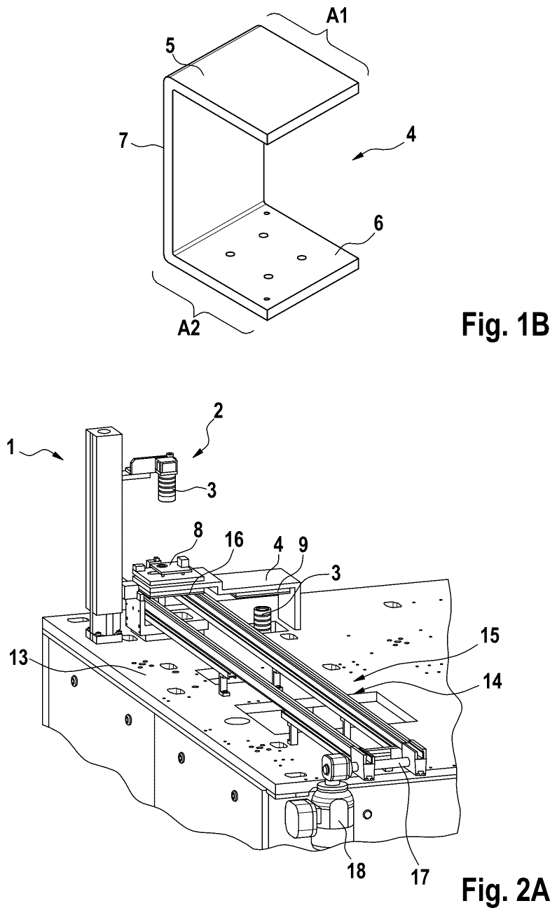

FIG. 2A and B shows a second embodiment example of the advantageous test system, according to the present invention.

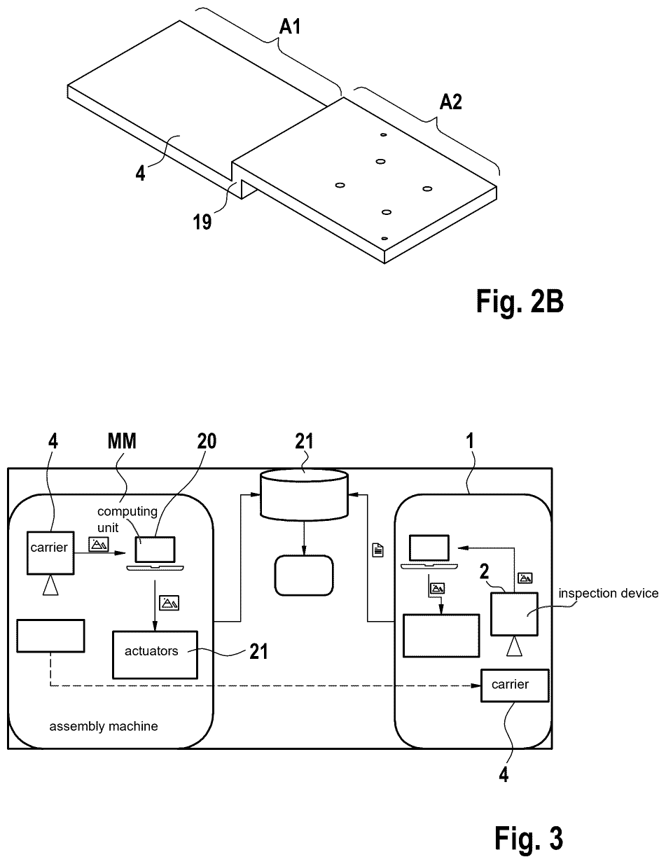

FIG. 3 shows a simplified illustration of a use of the test system, according to an example embodiment of the present invention.

### DETAILED DESCRIPTION OF EXAMPLE EMBODIMENTS

FIG. 1 shows a simplified perspective view of an advantageous test system 1 for an inspection device 2. The inspection device 2 is configured to acquire the orientation and position of two assembly elements to be connected together in an automated assembly machine in order to then control the assembly machine in such a way that the assembly elements are optimally brought together and connected to one another. A first assembly element can be a printed circuit board, for instance, and a second assembly element can be a microprocessor to be placed on the printed circuit board. For this purpose, the inspection device can comprise a camera 3, as in the present embodiment example, or a plurality of cameras to acquire the two or also more than two assembly elements prior to assembly.

The test system 1 presented here serves to ascertain the working parameters of the inspection device 2 in order to calibrate the inspection device 2 for later operation in the assembly line or an assembly machine, or to control it depending on the acquired working parameters in such a way that the assembly elements are optimally joined together. The objective of the advantageous test system 1 is to ascertain the capabilities of the inspection device 2. For this purpose, the test system 1 uses an advantageous carrier 4, which is configured as one rigid or stiff piece. The specific dimensions and configurations of the carrier 4 can be designed depending on the boundary conditions of the assembly machine, for example depending on the number of cameras being used by the inspection device 2 or depending on the assembly elements to be assembled. The advantageous test system 1 can be used in assembly machines that are configured to orient components or assembly elements relative to one another with the objective of improving the precision and efficiency of the orientation process and thus contributing to the overall efficiency and quality of the production line.

FIG. 1B shows only the carrier 4 in a perspective view. The carrier is configured to provide a stable, firm and precise platform for holding the assembly elements during the inspection process. The purpose of the carrier is to minimize errors and inconsistencies that can occur when the assembly elements are handled.

According to the first embodiment example, the carrier 4 is U-shaped, with two legs 5, 6 that are connected to one another by a connecting section 7 and disposed opposite to one another. As a result of the U-shape, the legs 5, 6 are also spaced apart from one another. The legs 5, 6 are preferably oriented parallel to one another as shown here. The legs 5, 6 each form a section A1, A2 of the carrier, wherein each one of the sections A1, A2 is assigned one of the assembly elements.

A respective holder 8, 9 for an assembly element, is disposed on each of the sections A1, A2 or legs 5, 6. The holders 8, 9 are disposed on the sides of the legs 5, 6 that face one another and are thus also opposite one another. The holders 8, 9 are fixedly connected to the respective leg 5, 6.

The respective holder preferably comprises a clamping device 10, 11, by means of which a respective assembly element can be clamped to the respective holder 8, 9 to fasten it. This ensures that the assembly element rests securely and permanently against the respective holder and thus against the carrier 4. Clamping the assembly elements to the carrier 4 guarantees that the test system 1 ensures that measurements carried out by the inspection device 2 accurately acquire the desired position, orientation and dimensions of the assembly elements. The test system 1 ensures that the accuracy, reliability and repeatability of the performance of the inspection device 2 are permanently ensured, which advantageously supports product quality, in particular in the product manufacturing process.

The U-shape of the carrier 4 according to the first embodiment example provides optimum stability and precision and serves in particular to accommodate at least parts of the inspection device 2. Thus, as shown in the embodiment example of FIG. 1A, the carrier 4 is configured such that at least the camera 3 and an optical prism 12 assigned to the camera are disposed in the space between the two legs 5 and 6. The prism 12 splits the beam path of the camera 3 into two beam directions, so that, in the test position, the one camera 3 can acquire both assembly elements held on the holders 8, 9 at the same time.

For examining the inspection device 2, the test system 1 also comprises a frame 13 to which the inspection device 2 is fastened, as well as a transport device 14, which is likewise disposed on the frame 13 and serves to move the carrier 4 from the test position shown in FIG. 1A, in which the inspection device 2 is positioned at least partly within the carrier 4, to a further away rest position. For this purpose, the transport device 14 here comprises a rail guide 15 with two parallel guide rails along which the carrier 4 can be moved.

The carrier 4 preferably comprises a coupling element 16 which is configured to be moved linearly along the guide rails 15. The coupling element 16 is in particular fastened to an underside of the lower leg 6 facing away from the holders 9. The coupling element 16 is also configured to be connected to a conveyor belt 17, which can be driven by a controllable electric motor 18. The carrier 4 can therefore be moved from the rest position to the test position and back by controlling the electric motor 18 and driving the conveyor belt 17. The carrier 4 and/or the transport device 14 are in particular also configured to serve in the assembly machine to transport and provide the assembly elements, or to move the carrier 4 from the test system to the assembly machine and back.

Because the assembly elements always have the same position and orientation to one another thanks to the advantageous carrier 4, the camera device is always presented with the same “image” for examining the assembly elements. However, if the images acquired by the camera 3 nonetheless differ from one examination to the next, so-called temporary features or distinguishing features, which result from the properties of the inspection device 2 or the camera 3 itself, emerge. The deviations or temporary features are preferably used to ascertain working parameters of the camera 3 or the inspection device 2. The test system 1 is therefore in particular a system for evaluating temporary characteristics in optical test systems or inspection devices.

To acquire the working parameters of the inspection device 2, the carrier 4 is repeatedly moved into the test position and back into the rest position. Whenever the carrier 4 is in the test position, the inspection device 2 is controlled to acquire and evaluate the assembly elements. Ideally, the assembly elements in this test system are the assembly elements that are later also to be joined together by the assembly machine. Alternatively, they are test objects, the only purpose of which is to acquire the performance capability and the working parameters of the inspection device 2. The test system 1 can therefore also include test assembly elements.

The acquired data from assembly elements are stored and then compared to one another in order to detect deviations from which the working parameters of the inspection device 2 are then ascertained.

FIG. 2 shows a further embodiment example, in which elements described above in connection with the first embodiment example are provided with the same reference signs and reference is made in this respect to the above description. The following focuses primarily on the differences.

In contrast to the above-described embodiment example, the carrier 4 is now Z-shaped. FIG. 2A shows the test system 1 in a perspective view, while FIG. 2B shows only the carrier 4 in a perspective view. The carrier 4 again comprises the two sections A1, A2, to each of which a holder 8, 9 is fastened. The sections A1, A2 are fixedly and integrally connected to one another by a transverse section 19. The sections A1, A2 project from the cross-section 19 from different sides, and preferably lie on different planes that are aligned parallel and spaced apart from one another which results in the Z-shape.

The coupling element 16, by means of which the carrier 4 is supported on the rail guide 15 in a longitudinally displaceable manner, is again fastened to one of the sections A1, A2, this time in section A1. The holders 8, 9 have been disposed on different sides of the sections A1, A2, or on sides of the sections that face away from one another, so that, in the image of FIG. 2A, the holder 8 is disposed on an upper side and the holder 9 is disposed on an underside of the section A2.

In this case, the carrier 4 is configured for an inspection device 2 that comprises two cameras 3 which are disposed at different positions to acquire the assembly elements. In this case, one camera 3 is disposed above the holder 8 and one camera is disposed below the holder 9 in the test position of the carrier 4. The method for determining the working parameters of the inspection device 4, however, is to be carried out as described above. Here, too, this results in the aforementioned advantages.

For the production of the carrier 4, forces that can act on the carrier 4 during the test process and/or the assembly process are ascertained.

Both static and dynamic forces, and also shear forces, torsional forces and reaction forces are ascertained, in particular taking into account specifiable safety factors. The choice of material takes into account strength, stiffness, durability, weight, compatibility and cost, and has led to aluminum 6061, AISI 304 stainless steel or SAE 1045 carbon steel, for example, as preferred materials for the carrier 4.

FIG. 3 shows a simplified illustration of an example use of the advantageous test system 1. The working parameters of the inspection device 2 are ascertained here with the aid of the advantageous carrier 4. To do this, the carrier 4 is first placed into an assembly machine MM and an assembly element is fastened to each of the holders 8, 9. The assembly elements have temporary characteristics that can be lost during the measurement process. The advantageous configuration of the carrier 4 ensures that this does not happen by maintaining the orientation and arrangement of the assembly elements relative to one another even when the carrier 4 is being moved. The assembly machine also comprises an inspection device 2 to bring about the orientation of the assembly elements relative to one another during operation, wherein the inspection devices 2 are identically configured. Among other things, this involves the use of a computing unit 20, which controls actuators 21 of the assembly machine MM depending on the camera images of the inspection device 2 in order to join the assembly elements. After the inspection device 2 has acquired the assembly elements, the carrier 4 is preferably moved to the test inspection device 2, for instance with the aid of the transport device 14, in order to acquire the assembly elements. The results of the two measurements are preferably provided to a central processing unit 22, which determines the working parameters and the performance capability of the inspection device 2 depending on the measurements that have been carried out.

1-10. (canceled)

11. A test system for an optical inspection device of an automated assembly machine, comprising:
a carrier configured to hold at least one assembly element to be assembled; and
a transport device configured to transport the carrier into a test position and into a rest position away from the test position;
wherein the at least one optical inspection device can be assigned or is assigned to the test position, and
wherein the carrier includes a first holder for a first assembly element of the at least one assembly element and a second holder for a second assembly element of the at least one assembly element, wherein the first and second holders are fixedly disposed relative to one another on the carrier.

12. The test system according to claim 11, wherein the first and second holders each include at least one clamping device for fastening the first assembly element and the second assembly element, respectively.

13. The test system according to claim 11, wherein the carrier includes a first section which holds the first holder, and a second section which holds the second holder, wherein the first section and the second section lie in planes which are offset and/or inclined relative to one another.

14. The test system according to claim 13, wherein the first second and the second section are formed in one piece with one another.

15. The test system according to claim 11, wherein the carrier has a U-shaped profile with two spaced-apart opposite legs and a connecting section which connects the legs to one another.

16. The test system according to claim 15, wherein one of the first and second holders is disposed on each of sides of the legs that face one another.

17. The test system according to claim 15, wherein the inspection device includes an optical prism that is positioned between the legs when the carrier is in the test position.

18. The test system according to claim 13, wherein the carrier has a Z-shaped profile in a longitudinal extension of the carrier, wherein the first section and the second section are connected to one another by a transverse section that is oriented perpendicular or at an angle to a longitudinal extension of the first and/or the second section.

19. The test system according to claim 11, wherein the transport device includes: (i) at least one rail guide for the carrier and/or (ii) a conveyor belt that can be connected or is connected to the carrier.

20. A method for operating a test system of an optical inspection device of an automated assembly machine, the test system including:
a carrier configured to hold at least one assembly element to be assembled, and
a transport device configured to transport the carrier into a test position and into a rest position away from the test position,
wherein the at least one optical inspection device can be assigned or is assigned to the test position, and
wherein the carrier includes a first holder for a first assembly element of the at least one assembly element and a second holder for a second assembly element of the at least one assembly element, wherein the first and second holders are fixedly disposed relative to one another on the carrier;
wherein the method comprises the following steps:
repeatedly moving the carrier with the first and second assembly elements fastened to the carrier, from the rest position to the test position by the transport device;
each time after reaching the test position, examining the first and second assembly elements by the inspection device; and
comparing examination results to one another acquire working parameters of at least one camera of the inspection device.
